(19) United States
(12) Patent Application Publication
(10) Pub. No.: US 2011/0085036 A1
(43) Pub. Date: Apr. 14, 2011

(54) High speed dome camera with optic-electric slip ring arrangement

(75) Inventors: Ya Jun Kong, Shenzhen (CN); Wei Jie Luo, Shenzhen (CN)

(73) Assignee: SHENZHEN INFINOVA LIMITED

(21) Appl. No.: 12/661,608

(22) Filed: Mar. 19, 2010

(30) Foreign Application Priority Data
Oct. 13, 2009 (CN) 200920205674.X

(51) Int. Cl. H04N 7/18

(52) U.S. Cl. 348/143; 348/E07.085

(57) ABSTRACT

A high speed dome camera includes a stationary unit, a moving unit including an image capturer for capturing an image signal, and an optic-electric slip ring arrangement provided between the moving unit and the stationary unit which includes an electric unit for power transmission, and an optical unit for transmitting the image signal from the moving unit to the stationary unit when the image capturer is driven to rotate in a high rotational speed. The optic-electric slip ring arrangement prevents the reduction of the quality of the high definition transmission, so that the present invention has the advantages of the higher transmitting speed, broader signal band, less signal distortion, and higher reliability, so as to increase the rotational speed.

### FIELD OF INVENTION

The present invention relates to a security monitoring camera, and more particularly to a high speed dome camera, which is adapted to transmit high definition video information via an optic-electric slip ring arrangement.

### DESCRIPTION OF RELATED ARTS

As the development of the modernization constructions and buildings, the pressure of the daily security management for controlling and responding the major terror, disasters, and other special emergency public events is increasing. In consider of the factors of monitoring view angle, blind area, mask area, and mobility etc, speed dome camera has the advantages of being able to control the rotational speed, high zoom speed, automatically scanning, navigating, and restoring operation trajectory. In other words, the speed dome camera is able to monitor a wide range via continuously high rotational speed of a camera block driving the lens of the video camera, so as to widely videotaping the environment. Normally, the camera block of the speed dome video camera is 360° continuously rotated, wherein the rotational speed of the camera block is 250 to 300 degree/second. The video information recorded from the video camera is transferred from the camera block to a stationary circuit, before the video information is sent from the stationary circuit to a monitoring center via the cable.

At present, the communication between the rotational part and the stationary part of the high speed dome camera is via an electrical slip ring. The principle of the electrical slip ring is that the electrical slip ring generally comprises two slip ring components, i.e. a conductive ring and an electrical brush, wherein one of the slip ring components is stationary while another one is movable. The stationary slip ring component is contacted with the movable slip ring component to electrically couple with each other. In other words, the two slip ring components are always electrically contacted with each other when the movable slip ring component is rotated. However, the housing of slip ring of the speed dome camera is relatively small to accommodate all the wires therewithin for electrically communication, so that the signals will significantly mutual inductance and interference and the electrical coupling is occurred. Meanwhile, the power and the signals also have interference to each other. Therefore, the band of the signals transmitted in the slip ring is limited, so the transmission speed and the quality of the signal are limited. In order to enhance the quality of the signal transmission, the rotational speed of the camera block is limited. When necessarily transmitting high definition video signal with higher reliable signal, less signal distortion, and wider signal band, the existing slip ring cannot meet the requirement.

### SUMMARY OF THE PRESENT INVENTION

An object of the present invention is to provide an optic-electric slip ring arrangement for the high speed dome camera, so that the speed dome camera is able to provide a relatively higher speed between the moving unit and the stationary unit, a wider transmitting band, less signal distortion, and higher reliability of the high definition video transmission. The rotational speed of the camera block can be as high as 400 degrees/second. The optical fiber of the optic-electric slip ring arrangement transmits the high definition video signal, while the electric part of the electrical slip ring is arranged for transmitting the power and controlling signal.

In order to accomplish the above objective, the present invention provides a high speed dome camera with optic-electric slip ring arrangement for transmitting the video information. The speed dome camera comprises a shell, a motor, a camera block, and a base which is stationary mounted within the shell, wherein a stator and a rotor of the motor are stationary connected to the base and the camera block respectively. The motor is arranged to generate an output to drive the camera block to rotate in a high rotational speed. The optic-electric slip ring arrangement is provided between the base and the camera block to connect the base with the camera block.

Accordingly, a base circuit board (PCB) is mounted at the base, wherein the base is stationary connected to the optic-electric slip ring arrangement. An optical receiver module is preferably mounted at the base and electrically connected to the base circuit board, wherein the optical receiver module is connected to the optic-electric slip ring arrangement via a base optical fiber. A camera block circuit board (PCB) is mounted in the camera block, and the camera block is fixedly connected to a sliding shaft of the optic-electric slip ring arrangement. An optical transmitter module is mounted in the camera block and electrically connected to the camera block circuit board. An image capturer, such as a video camera, is mounted in the camera block. The image capturer is electrically connected to the camera block circuit board via a flat cable. The optical transmitter module is connected to the optic-electric slip ring arrangement via a camera block optical fiber.

As described above, the optic-electric slip ring arrangement comprises an electric unit comprising a conductive ring and an electrical brush electrically connecting to a base wire and a camera block wire respectively, wherein the base wire is electrically connected to the base circuit board. The camera block wire is electrically connected to the camera block circuit board.

The signals which has relatively stronger resistance against interference, such as the power and the controlling signal, are electrically communicating via the electric unit of the optic-electric slip ring arrangement, which is provided between the camera block and the base.

The base circuit board comprises an opto-electrical converting circuit, an encoder/decoder, and a video stream format conversion module, wherein the camera block circuit board also comprises an opto-electrical converting circuit and an encoder/decoder. The encoder/decoder preferably is the FPGA encoder/decoder.

The principle the speed dome camera is that since the optical transmitter module is provided at the camera block to communicate with the optical receiver module provided in the base. The high definition image signal, i.e. video signal, from the image capturer is transmitted from the optical transmitter module, is modified with characters by the encoder/decoder, and is converted into an optical signal by the opto-electrical converting circuit. Then, the optical signal is transmitted to the optical receiver module via the optical fiber of the optic-electric slip ring arrangement. Since the optical receiver module is connected to the signal processing circuit, the optical signal is converted to high definition video signal via the optical receiver module and is transmitted to the signal processing circuit, and converted into high definition video signal for output. The signal which has relatively stronger resistance against interference, such as the power and the controlling signal, are electrically communicating via the electric unit of the optic-electric slip ring arrangement, which is provided at a position between the camera block and the base. When processing the high speed video stream data with wide signal band, the FPGA encoder/decoder, which adapts FIFO buffering technique, stores pixels of one frame outputted from the image capturer at the RAM within the FPGA encoder/decoder for data format conversion and character overlaying, and then output the RAM data to SERDES with twice of the sampling frequency, so that the band width of the data signal is half of the original. Meanwhile, the FIFO technology is able to insure the integrity of the video stream. The processing method avoids difficulties of finding the corresponding SERDES due to the plurality of cable, and uses the advantages of great ability of processing the data of the FPGA encoder/decoder, it is able to transmit the data stream and add the characters to the image during the vertical blanking interval of a video signal.

Therefore, the speed dome camera is able to provide a relatively higher speed between the moving unit and the stationary unit, a wider transmitting band, less signal distortion, higher reliability of the high definition video transmission, and better performance. The rotational speed of the speed dome camera with the optic-electric slip ring arrangement also is higher than that of the traditional speed dome camera.

These and other objectives, features, and advantages of the present invention will become apparent from the following detailed description, the accompanying drawings, and the appended claims.

### BRIEF DESCRIPTION OF THE DRAWINGS

FIG. 1 is a perspective sectional view of a high speed dome camera according to a preferred embodiment of the present invention.

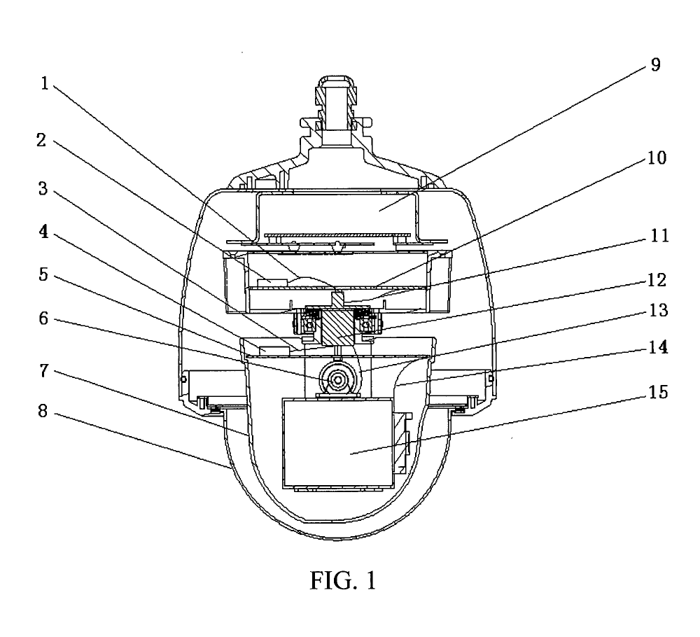

FIG. 2 is a block diagram of a system of the high speed dome camera according to the preferred embodiment of the present invention.

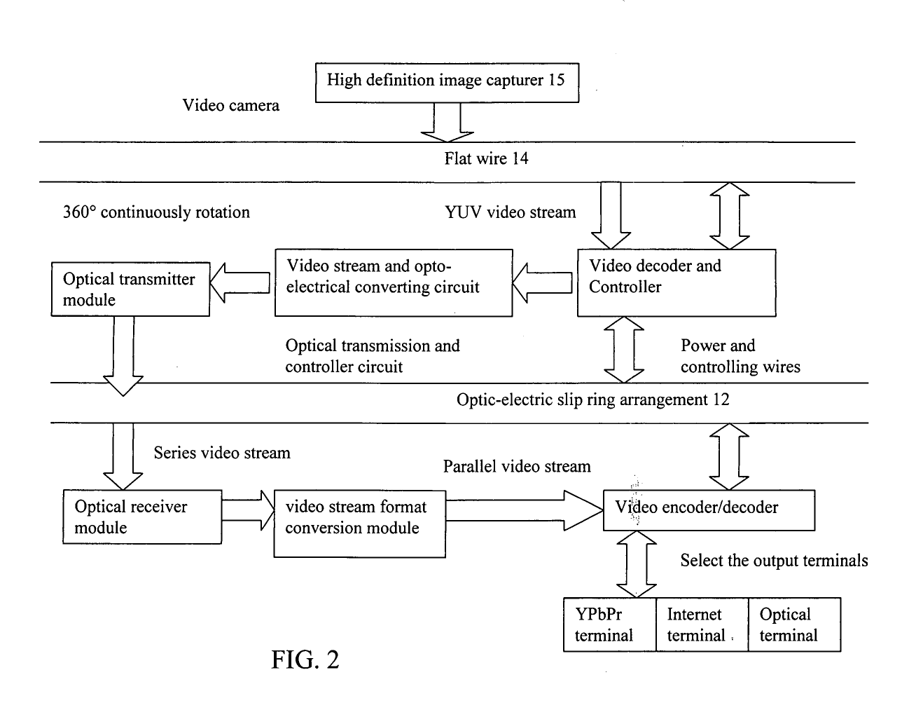

### DETAILED DESCRIPTION OF THE PREFERRED EMBODIMENT

The followings combined the figures provides the detail description along with the preferred embodiment for exemplary illustrating the present invention.

A preferred embodiment of the present invention:

A high speed dome camera comprises a stationary unit and a moving unit, wherein the stationary unit comprises a shell 8, and a base 9 stationary mounted within the shell 8. The moving unit comprises a camera block 7 supported within the shell 8, and a motor 6 mounted within the camera block 7. The high speed dome camera further comprises an optic-electric slip ring arrangement 12 provided between the base 9 and the camera block 7, wherein the optic-electric slip ring arrangement 12 comprises an optical unit for video signal transmission. The base 9 is stationary connected to the optic-electric slip ring arrangement 12, and the camera block 7 is connected to a sliding shaft of the optic-electric slip ring arrangement 12. A rotor of the motor 6 is fixedly connected to the optic-electric slip ring arrangement 12. A base circuit board 10 is supported in the base 9 and is electrically connected to an optical receiver module 2 of the optical unit. The optical receiver module 2 is connected to the optic-electric slip ring arrangement 12 via one or more base optical fibers 1. A camera block circuit board 5 is provided at the camera block 7. An optical transmitter module 4 is also mounted at the camera block 7 and is electrically connected to the camera block circuit board 5. A high definition image capturer 15, which is preferably a high definition video camera, is provided in the camera block 7 and is electrically connected to the camera block circuit board 5 via a flat cable 14. The optical transmitter module 4 is connected to the optic-electric slip ring arrangement 12 via one or more camera block optical fibers 3.

The optic-electric slip ring arrangement 12 further comprises an electric unit comprising a conductive ring and an electrical brush electrically connected to a base wire 11 and a camera block wire 13 respectively, wherein the conductive ring and the electrical brush is electrically contacted with each other. The base wire 11 is connected to the base circuit board 10, and the camera block wire 13 is connected to the camera block circuit board 5. The electric unit is provided between the stationary unit and the moving unit to enable the transmission of non-video signals between said moving unit and said stationary unit. The base circuit board 10 further comprises an opto-electrical converting circuit, a FPGA encoder/decoder, and a video stream format conversion module. The base 9 further comprises a CVBS terminal, YPbPr terminal, network terminal, opto-electrical terminal, controlling terminal, and power terminal, wherein the video terminal is able to be selectively arranged as needed, such as VGA, DVI, and LVDS etc. Each of the terminals is connected to one or more connection wires for external communication. The camera block circuit board 5 further comprises the opto-electrical converting circuit, the FPGA encoder/decoder.

The principle of the high speed dome camera is that the motor 6 generates an output to drive the camera block 7 to rotate in a high rotational speed, wherein the high definition image capturer 15 stationary supported within the camera block 7 captures a high definition image signal, i.e. video signal, when the image capturer 15 is actuated to rotate. The high definition image signal is modified, such as added characters, via the FPGA encoder/decoder, and is then converted into optical signal through the opto-electrical converting circuit. The optical signal is transmitted to the optic-electric slip ring arrangement 12 from the optical transmitter module 4 via the camera block optical fiber 3. After the optic-electric slip ring arrangement 12 receives the optical signal, the optical signal is sent to the optical receiver module 2 via the base optical fiber 1. Then, the optical signal is converted back to the high definition image signal by the opto-electrical converting circuit and the video stream format conversion module at the camera block circuit board 5, such that the image signal will be converted into video format by the FPGA encoder/decoder and will be externally outputted.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A high speed dome camera, comprising:
a stationary unit which comprises a shell and a base stationary mounted within said shell;
a moving unit which comprises a camera block, a motor supported within said camera block, and an image capturer driven to be rotated by said motor for capturing an image signal; and
an optic-electric slip ring arrangement coupling between said moving unit and said stationary unit.

2. The high speed dome camera, as recited in claim 1, further comprising an optical transmitter module mounted in said camera block for transmitting said image signal from said image capturer, and an optical receiver module mounted in said base to receive said image signal from said optical transmitter module through said optic-electric slip ring.

3. The high speed dome camera, as recited in claim 2, further comprising a camera block circuit board provided in said camera block to electrically connect to said optical transmitter module, and a base circuit board supported in said base to electrically connect to said optical receiver module.

4. The high speed dome camera, as recited in claim 3, wherein said optic-electric slip ring arrangement further comprises an electric unit provided between said moving unit and said stationary unit for power transmission, wherein said electric unit comprises a conductive ring electrically connected to said base circuit board, and an electrical brush which is electrically contacted with said conductive ring and said camera block circuit board.

5. The high speed dome camera, as recited in claim 4, wherein said conductive ring electrically connected to said base circuit board via a base wire, while said electrical brush is electrically connected to said camera block circuit board via a camera block wire.

6. The high speed dome camera, as recited in claim 3, wherein said camera block circuit board comprises an opto-electrical converting circuit for converting said image signal from said image capture into an optical signal to be transmitted, wherein said base circuit board comprises a corresponding opto-electrical converting circuit for converting said optical signal from said camera block circuit board back to said image signal after said optical signal is transmitted.

7. The high speed dome camera, as recited in claim 5, wherein said camera block circuit board comprises an opto-electrical converting circuit for converting said image signal from said image capture into an optical signal to be transmitted, wherein said base circuit board comprises a corresponding opto-electrical converting circuit for converting said optical signal from said camera block circuit board back to said image signal after said optical signal is transmitted.

8. The high speed dome camera, as recited in claim 1, wherein said image capturer is a high definition video camera adapted for capturing a high definition video signal as said image signal to be transmitted from said moving unit to said stationary unit through said optic-electric slip ring arrangement.

9. The high speed dome camera, as recited in claim 7, wherein said image capturer is a high definition video camera adapted for capturing a high definition video signal as said image signal to be transmitted from said moving unit to said stationary unit through said optic-electric slip ring arrangement.

10. The high speed dome camera, as recited in claim 2, wherein said optical receiver module is connected to said optic-electric slip ring arrangement via a base optical fiber, wherein said optical transmitter module is connected to said optic-electric slip ring arrangement via a camera block optical fiber.

11. The high speed dome camera, as recited in claim 9, wherein said optical receiver module is connected to said optic-electric slip ring arrangement via a base optical fiber, wherein said optical transmitter module is connected to said optic-electric slip ring arrangement via a camera block optical fiber.

12. A method of internally transmitting an image signal of a high speed dome camera which comprises a stationary unit and a moving unit, comprising the steps of:
(a) capturing said image signal by an image capturer of said moving unit, wherein said image capturer is driven to be rotated in a high rotational speed during image capturing;
(b) converting said image signal into an optical signal;
(c) transmitting said optical signal from said moving unit to said stationary unit through an optic-electric slip ring arrangement provided between said stationary unit and said moving unit; and
(d) converting said optical signal back to said image signal at said stationary unit.

13. The method, as recited in claim 12, wherein the step (c) further comprises the steps of:
(c.1) receiving said optical signal by an optical transmitter module provided at said moving unit; and
(c.2) transmitting said optical signal from said optical transmitter module to an optical receiver module through said optical slip ring, wherein said optical receiver module and said optical transmitter are provided in said stationary unit and said moving unit respectively.

14. The method, as recited in claim 13, wherein said optical transmitter module is connected to said optic-electric slip ring arrangement via a camera block optical fiber for transmitting said optical signal to said optic-electric slip ring arrangement, wherein said optical receiver module is connected to said optic-electric slip ring arrangement via a base optical fiber to receive said optical signal from said-optic-electric slip ring arrangement.

15. The method, as recited in claim 12, further comprising a step of providing an electric unit of said optic-electric slip ring arrangement between said stationary unit and said moving unit to enable the transmission of non-video signals between said moving unit and said stationary unit.

16. The method, as recited in claim 14, further comprising a step of providing an electric unit of said optic-electric slip ring arrangement between said stationary unit and said moving unit to enable the transmission of non-video signals between said moving unit and said stationary unit.

17. The method as recited in claim 12 wherein, in the step (b), said image signal is converted into said optical signal by an opto-electrical converting circuit provided in said moving unit, and in the step (d), said optical signal is converted back to said image signal by another opto-electrical converting circuit provided in said stationary unit.

18. The method as recited in claim 16 wherein, in the step (b), said image signal is converted into said optical signal by an opto-electrical converting circuit provided in said moving unit, and in the step (d), said optical signal is converted back to said image signal by another opto-electrical converting circuit provided in said stationary unit.

19. The method, as recited in claim 12, wherein said image capturer is a high definition video camera for capturing a high definition video signal as said image signal to be transmitted from said moving unit to said stationary unit through said optic-electric slip ring arrangement.

20. The method, as recited in claim 18, wherein said image capturer is a high definition video camera for capturing a high definition video signal as said image signal to be transmitted from said moving unit to said stationary unit through said optic-electric slip ring arrangement.
